(19) United States
(12) Patent Application Publication
(10) Pub. No.: US 2025/0014146 A1
(43) Pub. Date: Jan. 9, 2025

(54) ROTATION OF GRAPHICS LAYER IN VIDEO APPLICATION

(71) Applicant: QUALCOMM Incorporated, San Diego, CA (US)

(72) Inventors: Chun WANG, Markham (CA); Sumit GEMINI, Delhi (IN); Ye LIU, Richmond Hill (CA)

(21) Appl. No.: 18/346,746

(22) Filed: Jul. 3, 2023

(51) Int. Cl. G06T 3/60; G06T 9/00; G06T 11/00

(52) U.S. Cl. CPC G06T 3/60; G06T 9/00; G06T 11/00

(57) ABSTRACT

Aspects of the disclosure are directed to rotation of the graphics layer in video application. In accordance with one aspect, the apparatus includes a memory configured for storing a video layer in a compressed format and the graphics layer in an uncompressed format; and a display processing unit (DPU) coupled to the memory, the DPU configured for converting the graphics layer into an original compressed graphics layer, and for performing a graphics rotation on the original compressed graphics layer for generating a rotated compressed graphics layer. And, the method for rotation of a graphics layer includes converting the graphics layer into an original compressed graphics layer using a processing engine; and generating a rotated compressed graphics layer by using the processing engine to perform a graphics rotation on the original compressed graphics layer.

### TECHNICAL FIELD

This disclosure relates generally to the field of graphics layer rotation, and, in particular, to display processing unit (DPU) based rotation of the graphics layer in video application.

### BACKGROUND

Usage of a plurality of processing engines may exploit differences among the processing engines to optimize performance for a user application. For example, one processing engine may be more power efficient than another. However, certain processing engines may have operational constraints, such as data format, which restrict the type of operations that may be performed on those processing engines. Hence, there is a motivation in adapting a processing engine for certain processing operations to attain optimal performance.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides graphics layer rotation. Accordingly, an apparatus for rotating a graphics layer, the apparatus including a memory configured for storing a video layer in a compressed format and the graphics layer in an uncompressed format; and a display processing unit (DPU) coupled to the memory, the DPU configured for converting the graphics layer into an original compressed graphics layer, and for performing a graphics rotation on the original compressed graphics layer for generating a rotated compressed graphics layer.

In one example, the graphics rotation is an orthogonal rotation. In one example, the DPU is further configured to generate a rotated video layer for performing a video rotation on the video layer. In one example, the DPU is further configured to generate a composite rotated image by combining the rotated compressed graphics layer and the rotated video layer.

In one example, the apparatus further includes a video display coupled to the DPU, the video display configured to display the composite rotated image. In one example, the compressed format is a Universal Bandwidth Compression (UBWC) format. In one example, the uncompressed format is a linear RGB (red green blue) format.

Another aspect of the disclosure provides an apparatus for rotating a graphics layer, the apparatus including a non-transitory memory configured for storing a video layer in a compressed format and the graphics layer in an uncompressed format; means for converting the graphics layer into an original compressed graphics layer, and for performing a graphics rotation on the original compressed graphics layer for generating a rotated compressed graphics layer; and wherein the non-transitory memory is coupled to the means.

In one example, the compressed format is a Universal Bandwidth Compression (UBWC) format. In one example, the uncompressed format is a linear RGB (red green blue) format. In one example, the graphics rotation is an orthogonal rotation.

In one example, the apparatus further includes means for generating a rotated video layer by performing a video rotation on the video layer; and means for generating a composite rotated image by combining the rotated compressed graphics layer and the rotated video layer.

Another aspect of the disclosure provides a method for rotation of a graphics layer, the method including converting the graphics layer into an original compressed graphics layer using a processing engine; and generating a rotated compressed graphics layer by using the processing engine to perform a graphics rotation on the original compressed graphics layer.

In one example, the graphics layer is in an uncompressed format. In one example, the original compressed graphics layer is in a compressed format. In one example, the compressed format is a Universal Bandwidth Compression (UBWC) format. In one example, the uncompressed format is a linear RGB (red green blue) format. In one example, the graphics rotation is an orthogonal rotation.

In one example, the method further includes generating a rotated video layer by using the processing engine to perform a video rotation on a video layer. In one example, the method further includes using the processing engine to generate a composite rotated image by combining the rotated compressed graphics layer and the rotated video layer. In one example, the method further includes delivering the composite rotated image to a video display. In one example, the method further includes generating the video layer in the compressed format. In one example, the method further includes generating the graphics layer in the uncompressed format.

Another aspect of the disclosure provides a non-transitory computer-readable medium storing computer executable code, operable on a device including at least one processor and at least one memory coupled to the at least one processor, wherein the at least one processor is configured to implement rotation of a graphics layer, the computer executable code including instructions for causing a computer to convert the graphics layer into an original compressed graphics layer using a processing engine; and instructions for causing the computer to generate a rotated compressed graphics layer by using the processing engine to perform a graphics rotation on the original compressed graphics layer.

In one example, the non-transitory computer-readable medium of claim 1, further including instructions for causing the computer to generate a rotated video layer by using the processing engine to perform a video rotation on a video layer. In one example, the non-transitory computer-readable medium of claim 1, further including instructions for causing the computer to use the processing engine to generate a composite rotated image by combining the rotated compressed graphics layer and the rotated video layer.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example of an information processing system.

FIG. 2 illustrates a first example of an information processing system for a video playback data flow.

FIG. 3 illustrates a second example of an information processing system for a video playback data flow.

FIG. 4 illustrates an example flow diagram for implementing rotation of two layers of a video playback application.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

Modern information processing systems rely on a plurality of processing engines to execute a variety of computational and logical tasks. In one example, the plurality of processing engines is used to increase operational throughput (i.e., number of operations per second). For example, a central processing unit (CPU) may be used for general purpose computing and supervision of other processors. In another example, the plurality of processing engines may include specialized processing engines which are specifically designed to execute certain specialized tasks.

One common usage of an information processing system is for a mobile device (e.g., smartphone). In one example, the mobile device provides a variety of user applications such as mobile telephony, text messaging, email, Internet access, social media, video entertainment, gaming, audio programs, news updates, musical entertainment, financial data, etc. Many user applications require a video display to present information to a user. That is, the information processing system in the mobile device executes video processing to deliver video information to the video display.

In one example, an information processing system may include the following specialized processing engines:
1. graphics processing unit (GPU)—for graphics or numerical processing
2. display processing unit (DPU)—for display of image or video data onto a video
display
3. neural processing unit (NPU)—for neural processing tasks
4. image processing unit (IPU)—for image processing tasks
5. digital signal processor (DSP)—for digital signal processing tasks
6. network processor (NP)—for networking applications

One application of an information processing system is video processing; that is, the manipulation and display of video information. In one example, video information is a time-sequential series of image frames. For example, the image frames may have a total of N image pixels which are organized in a concatenation of J rows and K columns. For example, the video information may be displayed as a succession of image frames at a particular frame rate (in frames per second, fps). In one example, image pixels are fundamental elements of an image display or a video display.

In one example, information content may be quantified by an information metric in bits for a static information source, e.g., a single image frame, or in bits per second for a dynamic information source, e.g., video information. In one example, a bit is an atomic measure of information content having only two states generically denoted as zero or one. In one example, information of any type may be quantified in bits or in bits per second.

In one example, informational entropy quantifies the degrees of freedom, in bits, in an information source. For example, if a first information source has a first informational entropy of H₁ bits and a second information source has a second informational entropy of H₂ bits, then if H₁>H₂, the first information source has more degrees of freedom than the second information source. That is, a higher informational entropy corresponds to a greater uncertainty or randomness in the information and thus requires more bits for its representation.

In one example, information may be represented in two generic formats: uncompressed and compressed. For example, uncompressed information is information in its original form with an original source information rate. For example, compressed information is information in a reduced form with a compressed information rate. For example, the compressed information leverages the informational entropy by representing the information with fewer bits than the uncompressed information. In one example, the compressed information rate is less than the original source information rate. For example, the compressed information rate may be less than 10% of the original source information rate.

In one example, there are two image data types which may undergo manipulation and processing prior to displaying onto a display unit. In one example, a video layer is an actual imagery to be displayed onto a video display. In one example, the video layer is represented in a compressed format. In one example, the compressed format is a universal bandwidth compression (UBWC) format. In one example, a graphics layer is overlay data (e.g., comments, tags, notes, etc.) to be displayed onto the video display. In one example, the graphics layer is represented in an uncompressed format. In one example, the uncompressed format is a linear RGB (red green blue) format. In one example, the linear RGB format represents information as a superposition of a plurality of color basis vectors (e.g., red, green, blue) to synthesize an arbitrary image pixel.

In one example, a video playback application in a mobile device may send both the video layer and the graphics layer to the information processing system. For example, the graphics layer may include views, comments and overlay data which are to be displayed over video data from the video layer. In one example, the graphics layer is generated by the CPU of the information processing system. In one example, the graphics layer is represented in an uncompressed format (e.g., linear RGB format). In one example, the video layer is represented in a compressed format (e.g., UBWC format).

In one example, both the video layer and the graphics layer may need to be rotated by a rotation angle depending on the video display orientation relative to the user holding the mobile device. In one example, the rotation angle is 90 degrees (i.e., orthogonal rotation). In one example, the rotation angle is less than 90 degrees (i.e., non-orthogonal rotation). In one example, the rotation angle is greater than 90 degrees (i.e., also a non-orthogonal rotation).

In one example, a first processing engine is capable of performing rotation on two or more layers. In one example, the first processing engine performs rotation on two or more layers only if they are in compressed format (e.g., UBWC format). In one example, the first processing engine is a display processing unit (DPU). For example, the first processing engine is capable of rotating the video layer.

In one example, a second processing engine is capable of performing rotation on at least one layer in uncompressed format (e.g., linear RGB format). In one example, the second processing engine requires more dc power to perform rotation than the first processing engine. In one example, the second processing engine is a graphics processing unit (GPU). In one example, the second processing engine is capable of rotating the graphics layer.

In one example, for a video playback application in a mobile device, rotation of the video layer is performed by the DPU and rotation of the graphics layer is performed by the GPU. In one example, the DPU is more dc power efficient than the GPU.

In some applications, for example, video playback, it is desirable to provide a two-pass processing scheme by the DPU which allows rotation of both the video layer and the graphics layer with improved dc power efficiency.

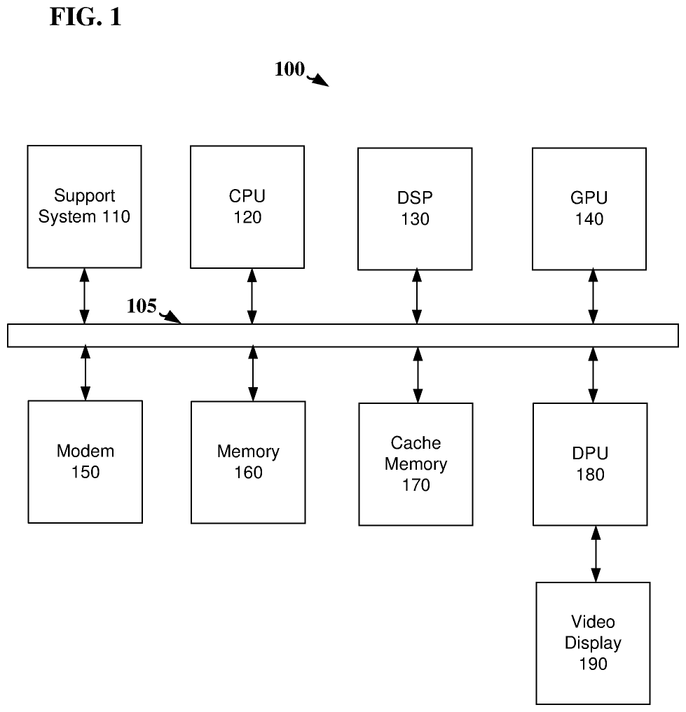

FIG. 1 illustrates an example of an information processing system 100. In one example, the information processing system 100 includes a plurality of processing engines such as a central processing unit (CPU) 120, a digital signal processor (DSP) 130, a graphics processing unit (GPU) 140, a display processing unit (DPU) 180, etc. In one example, various other functions in the information processing system 100 may be included such as a support system 110, a modem 150, a memory 160, a cache memory 170 and a video display 190. For example, the plurality of processing engines and various other functions may be interconnected by an interconnection databus 105 to transport data and control information. For example, the memory 160 and/or the cache memory 170 may be shared among the CPU 120, the GPU 140 and the other processing engines. In one example, the CPU 120 may include a first internal memory which is not shared with the other processing engines. In one example, the GPU 140 may include a second internal memory which is not shared with the other processing engines. In one example, any processing engine of the plurality of processing engines may have an internal memory which is not shared with the other processing engines.

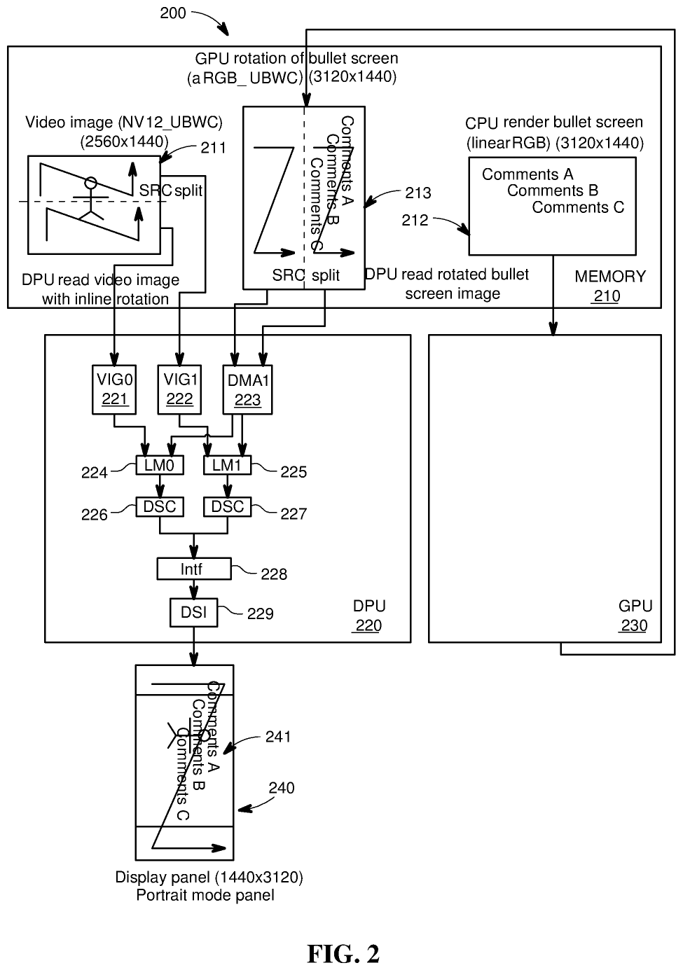

FIG. 2 illustrates a first example of an information processing system 200 for a video playback data flow. The first example of the information processing system 200 includes a memory 210, a display processing unit (DPU) 220, a graphics processing unit (GPU) 230, a video display 240 and a central processing unit (CPU) 250 (not shown). In one example, the memory 210 is a double data rate (DDR) memory.

In one example, the memory 210 stores a first video layer 211 with an initial orientation. In one example, the first video layer 211 includes a first video image. For example, the first video image is a time-sequential series of image frames. For example, the first video image may have a total of N image pixels which are organized in a concatenation of J rows and K columns. For example, J=1440 rows and K=2560 columns with a total of N=3,686,400 image pixels. For example, the first video layer 211 may be displayed as a succession of image frames at a particular frame rate (in frames per second, fps). In one example, the first video layer 211 is represented in a compressed format. For example, the compressed format is Universal Bandwidth Compression (UBWC) format.

In one example, the memory 210 stores a first graphics layer 212 with a first orientation. In one example, the first graphics layer 212 is a CPU render bullet screen. For example, the first graphics layer 212 may have a total of P image pixels which are organized in a concatenation of L rows and M columns. For example, L=1440 rows and L=3120 columns with a total of P=4,492,800 image pixels. In one example, the first graphics layer 212 is represented in an uncompressed format. For example, the uncompressed format is linear RGB format.

In one example, the memory 210 stores a second graphics layer 213 with a second orientation. In one example, the second orientation is rotated from the first orientation. In one example, the second orientation is rotated 90 degrees from the first orientation. In one example, the second graphics layer 213 is represented in an uncompressed format. For example, the uncompressed format is linear RGB format.

In one example, the graphics processing unit (GPU) 230 accepts the first graphics layer 212 with the first orientation as a GPU input. In one example, the GPU 230 rotates the first graphics layer 212 to produce the second graphics layer 213 with the second orientation as a GPU output. In one example, the GPU 230 operates with uncompressed format, for example, linear RGB format.

In one example, the display processing unit (DPU) 220 includes a first video image processing engine (VIG0) 221, a second video image processing engine (VIG1) 222, a direct memory access (DMA) 223, a first layer mixer (LM0) 224, a second layer mixer (LM1) 225, a first display screen compressor (DSC) 226, a second display screen compressor (DSC) 227, an interface (Intf) 228 and a display stream interface (DSI) 229. In one example, the DPU 220 accepts the first video layer 211 with the initial orientation as a first DPU input which is fed to the first video image processing engine (VIG0) 221 and the second video image processing engine (VIG1) 222. In one example, a video image processing engine (VIG) may be a video image scaler which retrieves a video image from memory and performs video processing such as color space conversion, image size scaling and image rotation, if necessary. In one example, each VIG has an identical design. In one example, a plurality of video image processing engines may operate in parallel to handle a high resolution or a high refresh rate display to increase video processing throughput (e.g., double, quadruple, etc.) for a given display. In one example, direct memory access (DMA) may be a graphics image handling pipeline which retrieves a graphics image from memory and delivers it to a display. In one example, a plurality of DMAs may operate in parallel to handle high resolution or high refresh rate display to increase graphics image processing throughput. In one example, a DMA pipeline may not handle color space conversion, image scaling and image rotation. In one example, a layer mixer (LM) handles an overlay of multiple graphics and video layers from a plurality of VIGs and a plurality of DMAs before sending an overlayed image to a display. In one example, a display screen compressor (DSC) compresses display data to reduce bandwidth or data rate on a connection between a display processor and a display. In one example, a display stream interface (DSI) may be used to connect a display processor to an actual display.

In one example, the DPU 220 accepts the second graphics layer 213 with a second orientation as a second DPU input which is fed to the direct memory access (DMA) 223. In one example, the first video layer 211 with the initial orientation is rotated by the first video image processing engine (VIG0) 221 and the second video image processing engine (VIG1) 222 to produce a second video layer 214 (not shown) with a rotated orientation. In one example, the rotated orientation is rotated from the initial orientation. In one example, the rotated orientation is rotated 90 degrees from the initial orientation. In one example, the first video image processing engine (VIG0) 221 and the second video image processing engine (VIG1) 222 operate with the compressed format (e.g., UBWC format).

In one example, the second video layer 214 and the second graphics layer 213 undergo additional processing by the first layer mixer (LM0) 224, the second layer mixer (LM1) 225, the first display screen compressor (DSC) 226, the second display screen compressor (DSC) 227, the interface (Intf) 228 and the display stream interface (DSI) 229 to produce a composite rotated image 241 in the video display 240. In one example, the composite rotated image 241 includes a superposition of the second video layer 214 and the second graphics layer 213 with the same orientation.

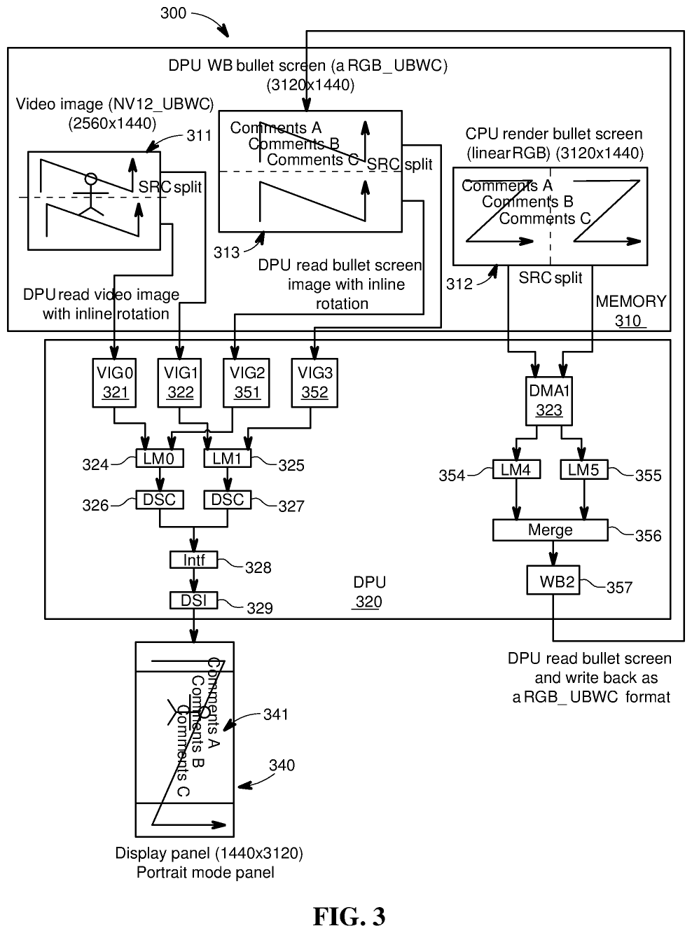

FIG. 3 illustrates a second example of an information processing system 300 for a video playback data flow. The second example of the information processing system 300 includes a memory 310, a display processing unit (DPU) 320, a graphics processing unit 330 (not shown), a video display 340 and a central processing unit (CPU) 350 (not shown). In one example, the memory 310 is a double data rate (DDR) memory.

In one example, the memory 310 stores a first video layer 311 with an initial orientation. In one example, the first video layer 311 includes a first video image. For example, the first video image is a time-sequential series of image frames. For example, the first video image may have a total of N image pixels which are organized in a concatenation of J rows and K columns. For example, J=1440 rows and K=2560 columns with a total of N=3,686,400 image pixels. For example, the first video layer 311 may be displayed as a succession of image frames at a particular frame rate (in frames per second, fps). In one example, the first video layer 311 is represented in a compressed format. For example, the compressed format is Universal Bandwidth Compression (UBWC) format.

In one example, the memory 310 stores a first graphics layer 312 with a first orientation. In one example, the first graphics layer 312 is a CPU render bullet screen. For example, the first graphics layer 312 may have a total of P image pixels which are organized in a concatenation of L rows and M columns. For example, L=1440 rows and L=3120 columns with a total of P=4,492,800 image pixels. In one example, the first graphics layer 312 is represented in an uncompressed format. For example, the uncompressed format is linear RGB format.

In one example, the memory 310 stores a second graphics layer 313 with the first orientation. In one example, the second graphics layer 313 is represented in a compressed format. In one example, the compressed format is UBWC format. In one example, a source (SRC) split is a processing function which splits a video or graphics source image into multiple sections or slices. For example, each slice may be assigned to a VIG or DMA pipeline in the display processor. For example, a division of the video or graphics source image into multiple slices allows parallel processing by a plurality of VIG or DMA source pipelines to provide increased processing throughput for a high resolution and/or high refresh rate display with a specific pixel throughput speed target.

In one example, the display processing unit (DPU) 320 includes a first video image processing engine (VIG0) 321, a second video image processing engine (VIG1) 322, a third video image processing engine (VIG2) 351, a fourth video image processing engine (VIG3) 352, a first layer mixer (LM0) 324, a second layer mixer (LM1) 325, a first display screen compressor (DSC) 326, a second display screen compressor (DSC) 327, an interface (Intf) 328 and a display stream interface (DSI) 329.

In one example, the display processing unit (DPU) 320 also includes a direct memory access (DMA) 323, a third layer mixer (LM4) 354, a fourth layer mixer (LM5) 355, a merge function 356 and a display image writeback module (WB2) 357.

In one example, the DPU 320 accepts the first graphics layer 312 as input to the direct memory access (DMA) 323. In one example, the third layer mixer (LM4) 354 and the fourth layer mixer (LM5) 355 perform a format conversion on the first graphics layer 312. In one example, the format conversion is from uncompressed format to compressed format. In one example, the format conversion is from linear RGB format to UBWC format. In one example, the format conversion is performed to facilitate operation by the DPU 320. In one example, the merge function 356 and the display image writeback module (WB2) 357 provide further processing to produce the second graphics layer 313. In one example, the second graphics layer 313 is a compressed version of the first graphics layer 312. In one example, the second graphics layer is stored in memory 310.

In one example, DMA 323 may be used to fetch an original graphics image in RGB linear format. For example, DMA 323 may fetch a left half and a right half of the image in parallel to provide increased image processing throughput. to double the throughput of the image processing. In one example, the third layer mixer LM4 354 and the fourth layer mixer LM5 355, which operate in parallel, may provide further processing such as layer combining, if more than one layer is present. In one example, the merge function 356 may combine the left half and the right half of the image to form a composite image.

In one example, the display image writeback module (WB2) 357 may be used to write the image back to memory. In one example, WB2 356 may also perform UBWC compression on the image to produce a UBWC compressed format. In one example, VIG0 321 and VIG1 322 may be used to process the video image in parallel, where VIG0 321 and VIG1 322 each process half of the video image. In one example, VIG0 321 and VIG1 322 may perform color space conversion, scaling and image rotation. In one example, VIG2 351 and VIG3 352 may be used to process the graphics image in parallel, where VIG2 351 and VIG3 352 each process half of the graphics image by performing an image rotation.

In one example, LM0 324 and LM1 325 operate in parallel to perform an overlay of the graphics image and the video image to produce an output image. For example, LM0 324 and LM1 325 each handle half of the output image.

In one example, the output image is compressed by a display screen compressor (DSC) prior to transmission to the interface (Intf) 328. In one example, the interface (Intf) 328 provides display timing information and supplies an output display image (pixel by pixel, line by line) to a display output which connects to the video display 340 via a physical connection. In one example, the physical connection uses the display stream interface (DSI) 329.

In one example, the DPU 320 accepts the first video layer 311 with the initial orientation as a first DPU input which is fed to the first video image processing engine (VIG0) 321 and the second video image processing engine (VIG1) 322. In one example, the first video layer 311 with the initial orientation is rotated by the first video image processing engine (VIG0) 321 and the second video image processing engine (VIG1) 322 to produce a second video layer 314 (not shown) with a rotated orientation. In one example, the rotated orientation is rotated from the initial orientation. In one example, the rotated orientation is rotated 90 degrees from the initial orientation. In one example, the first video image processing engine (VIG0) 321 and the second video image processing engine (VIG1) 322 operate with the compressed format (e.g., UBWC format).

In one example, the DPU 320 accepts the second graphics layer 313 with a first orientation as a second DPU input which is fed to the third video image processing engine (VIG2) 351 and the fourth video image processing engine (VIG3) 352. In one example, the second graphics layer 313 with the first orientation is rotated by the third video image processing engine (VIG2) 351 and the fourth video image processing engine (VIG3) 352 to produce a third graphics layer 315 (not shown) with a second orientation. In one example, the second orientation is rotated from the first orientation. In one example, the second orientation is rotated 90 degrees from the first orientation. In one example, the third video image processing engine (VIG2) 351 and the fourth video image processing engine (VIG3) 352 operate with the compressed format (e.g., UBWC format). In one example, the first orientation is the same as the initial orientation. In one example, the second orientation is the same as the rotated orientation.

In one example, the second video layer 314 and the third graphics layer 315 undergo additional processing by the first layer mixer (LM0) 324, the second layer mixer (LM1) 325, the first display screen compressor (DSC) 326, the second display screen compressor (DSC) 327, the interface (Intf) 328 and the display stream interface (DSI) 329 to produce a composite rotated image 341 in the video display 340. In one example, the composite rotated image 341 includes a superposition of the second video layer 314 and the third graphics layer 315 with a same rotation angle. That is, the second video layer 314 and the third graphics layer 315 have an orientation after being rotated by the same rotation angle. In one example, the same rotation angle is 90 degrees (i.e., orthogonal rotation). In one example, the same rotation angle is less than or greater than 90 degrees (i.e., non-orthogonal rotation). In one example, the composite rotated image 341 includes both a video image and views, comments and overlay data which are displayed with the video image from the video layer.

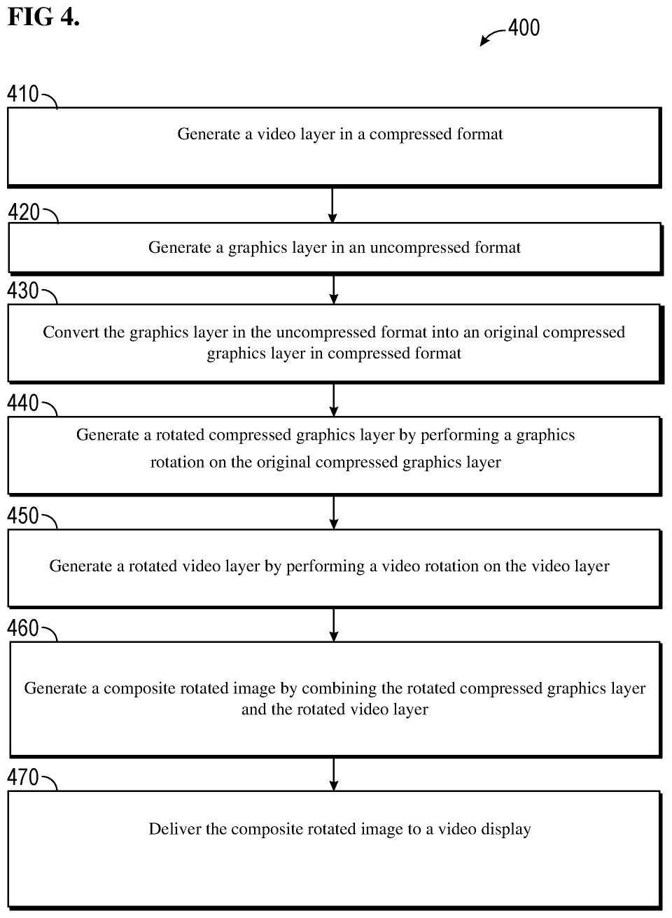

FIG. 4 illustrates an example flow diagram 400 for implementing rotation of two layers of a video playback application. In block 410, generate a video layer in compressed format. That is, a video layer is generated in compressed format.

In one example, the video layer is first produced in uncompressed format prior to a source coding procedure which generates the video layer in compressed format. In one example, the compressed format is Universal Bandwidth Compression (UBWC) format. In one example, the video layer is a time-sequential series of image frames. For example, the image frames may have a total of N image pixels which are organized in a concatenation of J rows and K columns. For example, the video information may be displayed as a succession of image frames at a particular frame rate (in frames per second, fps). In one example, the video layer may be stored in a memory. In one example, the memory is a DDR memory. In one example, the memory is included in a mobile device. In one example, the memory is a non-transitory memory.

In block 420, generate a graphics layer in an uncompressed format. That is, a graphics layer is generated in uncompressed format. In one example, the uncompressed format is a linear RGB (red green blue) format. In one example, the graphics layer is a CPU render bullet screen. For example, the graphics layer may have a total of P image pixels which are organized in a concatenation of L rows and M columns. In one example, the graphics layer may be stored in the memory. In one example, the memory is the DDR memory. In one example, the memory is a non-transitory memory.

In block 430, convert the graphics layer in uncompressed format into an original compressed graphics layer in compressed format. That is, the graphics layer in uncompressed format is converted into an original compressed graphics layer in compressed format. In one example, the compressed format is UBWC format. In one example, the conversion from uncompressed format to compressed format is performed by a first processing engine. In one example, the first processing engine is a display processing unit (DPU). In one example, the conversion from uncompressed format to compressed format is performed by a concatenation of two parallel processing paths in the first processing engine. In one example, the original compressed graphics layer may be stored in the memory. In one example, the memory is the DDR memory. In one example, the first processing engine is included in the mobile device.

In block 440, generate a rotated compressed graphics layer by performing a graphics rotation on the original compressed graphics layer. That is, a rotated compressed graphics layer is generated by performing a graphics rotation on the original compressed graphics layer. In one example, the graphics rotation is performed by the first processing engine. In one example, the graphics rotation is performed by a first segment of a video image processing engine in the first processing engine. In one example, the graphics rotation results in an orientation of the rotated compressed graphics layer that is orthogonal to the original compressed graphics layer. In one example, the graphics rotation results in an orientation of the rotated compressed graphics layer that is non-orthogonal to the original compressed graphics layer. In one example, the graphics rotation depends on a video display orientation relative to a user holding the mobile device.

In block 450, generate a rotated video layer by performing a video rotation on the video layer. That is, the rotated video layer is generated by performing a video rotation on the video layer. In one example, the video rotation is performed by the first processing engine. In one example, the video rotation is performed by a second segment of the video image processing engine in the first processing engine. In one example, the video rotation results in an orientation of the rotated video layer that is orthogonal to the video layer. In one example, the graphics rotation results in an orientation of the rotated video layer that is non-orthogonal to the video layer. In one example, the graphics rotation depends on the video display orientation relative to the user holding the mobile device.

In block 460, generate a composite rotated image by combining the rotated compressed graphics layer and the rotated video layer. That is, a composite rotated image is generated by combining the rotated compressed graphics layer and the rotated video layer. In one example, the composite rotated image is combined by the first processing engine. In one example, the composite rotated image has a composite orientation which depends on the video display orientation relative to the user holding the mobile device.

In block 470, deliver the composite rotated image to a video display. That is, the composite rotated image is delivered to the video display. In one example, the video display converts the composite rotated image from compressed format to uncompressed format prior to displaying on the video display. In one example, the video display is included in the mobile device.

In one aspect, one or more of the steps in FIG. 4 may be executed by one or more processors which may include hardware, software, firmware, etc. The one or more processors, for example, may be used to execute software or firmware needed to perform the steps in the flow diagram of FIG. 4. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. An apparatus for rotating a graphics layer, the apparatus comprising:
a memory configured for storing a video layer in a compressed format and the graphics layer in an uncompressed format; and
a display processing unit (DPU) coupled to the memory, the DPU configured for converting the graphics layer into an original compressed graphics layer, and for performing a graphics rotation on the original compressed graphics layer for generating a rotated compressed graphics layer.

2. The apparatus of claim 1, wherein the graphics rotation is an orthogonal rotation.

3. The apparatus of claim 1, wherein the DPU is further configured to generate a rotated video layer for performing a video rotation on the video layer.

4. The apparatus of claim 3, wherein the DPU is further configured to generate a composite rotated image by combining the rotated compressed graphics layer and the rotated video layer.

5. The apparatus of claim 4, further comprising a video display coupled to the DPU, the video display configured to display the composite rotated image.

6. The apparatus of claim 4, wherein the compressed format is a Universal Bandwidth Compression (UBWC) format.

7. The apparatus of claim 6, wherein the uncompressed format is a linear RGB (red green blue) format.

8. An apparatus for rotating a graphics layer, the apparatus comprising:
a non-transitory memory configured for storing a video layer in a compressed format and the graphics layer in an uncompressed format;
means for converting the graphics layer into an original compressed graphics layer, and for performing a graphics rotation on the original compressed graphics layer for generating a rotated compressed graphics layer; and
wherein the non-transitory memory is coupled to the means.

9. The apparatus of claim 8, wherein the compressed format is a Universal Bandwidth Compression (UBWC) format.

10. The apparatus of claim 8, wherein the uncompressed format is a linear RGB (red green blue) format.

11. The apparatus of claim 9, further comprising:
means for generating a rotated video layer by performing a video rotation on the video layer; and
means for generating a composite rotated image by combining the rotated compressed graphics layer and the rotated video layer.

12. The apparatus of claim 8, wherein the graphics rotation is an orthogonal rotation.

13. A method for rotation of a graphics layer, the method comprising:
converting the graphics layer into an original compressed graphics layer using a processing engine; and
generating a rotated compressed graphics layer by using the processing engine to perform a graphics rotation on the original compressed graphics layer.

14. The method of claim 13, wherein the graphics layer is in an uncompressed format.

15. The method of claim 14, wherein the original compressed graphics layer is in a compressed format.

16. The method of claim 15, further comprising generating a rotated video layer by using the processing engine to perform a video rotation on a video layer.

17. The method of claim 16, further comprising using the processing engine to generate a composite rotated image by combining the rotated compressed graphics layer and the rotated video layer.

18. The method of claim 17, further comprising delivering the composite rotated image to a video display.

19. The method of claim 18, further comprising generating the video layer in the compressed format.

20. The method of claim 19, wherein the compressed format is a Universal Bandwidth Compression (UBWC) format.

21. The method of claim 19, further comprising generating the graphics layer in the uncompressed format.

22. The method of claim 21, wherein the uncompressed format is a linear RGB (red green blue) format.

23. The method of claim 13, wherein the graphics rotation is an orthogonal rotation.

24. A non-transitory computer-readable medium storing computer executable code, operable on a device comprising at least one processor and at least one memory coupled to the at least one processor, wherein the at least one processor is configured to implement rotation of a graphics layer, the computer executable code comprising:
instructions for causing a computer to convert the graphics layer into an original compressed graphics layer using a processing engine; and
instructions for causing the computer to generate a rotated compressed graphics layer by using the processing engine to perform a graphics rotation on the original compressed graphics layer.

25. The non-transitory computer-readable medium of claim 24, further comprising instructions for causing the computer to generate a rotated video layer by using the processing engine to perform a video rotation on a video layer.

26. The non-transitory computer-readable medium of claim 24, further comprising instructions for causing the computer to use the processing engine to generate a composite rotated image by combining the rotated compressed graphics layer and the rotated video layer.
